(19) United States
(12) Patent Application Publication
(10) Pub. No.: US 2013/0168904 A1
(43) Pub. Date: Jul. 4, 2013

(54) System and Method for Accelerating Interacting Nanostructures

(71) Applicant: Fabrizio Pinto, Monrovia, CA (US)

(72) Inventor: Fabrizio Pinto, Monrovia, CA (US)

(21) Appl. No.: 13/684,438

(22) Filed: Nov. 23, 2012

Related U.S. Application Data
(60) Provisional application No. 61/562,972, filed on Nov. 22, 2011.

(51) Int. Cl. B29C 67/00

(52) U.S. Cl. CPC B29C 67/0014
USPC 264/484

(57) ABSTRACT

A core is moved within a surrounding nanotube shell by modulating the magnitude of the dispersion force therebetween along successive portions of the nanotube shell.

### STATEMENT OF RELATED CASES

This application claims priority of U.S. Provisional Patent Application 61/562,972 filed Nov. 22, 2011, which is incorporated herein by reference. This application is related to U.S. Pat. No. 8,299,761, which is incorporated by reference herein.

### FIELD OF THE INVENTION

The present invention relates to methods and apparatus for creating movement in nanostructures.

### BACKGROUND OF THE INVENTION

Carbon nanotubes (“CNTs”) are allotropes of carbon with a cylindrical structure. They are members of the fullerene structural family. The name “nanotube” derives from their characteristically long (at least in terms of their length-to-diameter aspect ratio), hollow structure, wherein the walls are sheets of graphene that have a thickness of one atom.

CNTs can be single walled or multi-walled. Multi-walled CNTs consist of two or more concentric tubes of graphite. The interlayer distance (i.e., distance between the walls of adjacent tubes) in a multi-walled CNT is about 3.4 angstroms. For simplicity, the following discussion refers to multi-wall CNTs having two walls: an inner “core” and an outer tube.

There has been much interest in multi-walled CNTs because of their ability to “telescope.” In this context, a telescoping nanotube is a multi-walled CNT in which the core is accessed and mechanically pulled at least part way out of the outer tube. Such telescoping CNTs have a variety of potential nanomechanical implementations, such as use as acutators, ultra-low friction bearings, and gigahertz oscillators.

Currently, a telescoping nanotube is created by forming a multi-walled CNT via known techniques and removing the capped free end of the multi-walled CNT via acid etching, saturated current, electronic pulse, or mechanical strain techniques to provide access to the inner cylinder. A nanorobotic manipulator is then used to pull the core partially out of the outer tube.

It is notable that the inner core of the multi-walled CNT tends to stay motionless within the outer cylindrical due to the van der Waals interaction between the two cylinders, as well as atomic-scale mechanisms, such as interatomic locking. Experiments have shown that the force due to the latter mechanism is substantially smaller than the restoring force created by the van der Waals interaction. Consequently, a force must be applied to the core to cause it to move within the outer tube. And, in fact, the restoring force resulting from excess van der Waals interaction energies that result as the core is partially removed from the outer tube drives the core to retract within the outer tube once released from the extraction device.

Experimental studies have shown that electrostatic forces are able to overcome the van der Waals interaction. And, in fact, proposals for using a telescoping nanotube as an actuator, bearing, oscillator, etc., rely on the use of electrostatic forces to move inner core. However, the core cannot be moved by electrostatic forces until the core is at least partially exposed either by removing sections of the outer tube or extracting the core.

### BRIEF DESCRIPTION OF THE DRAWINGS

FIG. 1a depicts a two-segment outer wall nanotube containing a core moving under the action of modulated or varied dispersion forces in accordance with the illustrative embodiment of the present invention.

FIG. 1b depicts the first in a sequence of the figures that illustrate acceleration of a core through a segment of a nanotube shell. FIG. 1b depicts the core entering the segment at which time the dispersion force is “switched on” and the magnitude thereof is increased by adding energy to the system (such as by illumination with a laser, etc.). It will be understood that the dispersion forces are always in such a circumstance; what is being referenced is a localized increase or decrease that causes a force gradient.

FIG. 1c depicts the second figure in the acceleration sequence wherein the core reaches its maximum velocity and continues to travel toward the end of the segment of the nanotube shell.

FIG. 1d depicts the final figure of the sequence wherein the core is exiting the segment. The velocity of the core will begin to decrease as the core is no longer under the action of dispersion forces; that is, the dispersion forces are “switched off.”

FIG. 2a depicts a multi-walled carbon nanotube “accelerator” that is segregated, for pedagogical purposes, into three segments (n=1, n=2, and n=3). Such segmentation can be, but is not necessarily, a result of fabrication; segmentation can be functionally imposed by the localized application of dispersion force manipulation to each section. FIG. 2a depicts the first operation of a sequence that is illustrated in FIGS. 2a through 2c. In FIG. 2a, the core or “shuttle” is located at rest with its right edge between the first and second segment. Each segment of the shell is shown with “dark” walls. This means that there is no modulation (e.g., “on”-“off”, etc.) of the dispersion force from one segment to the next. Therefore, there is no force urging the core to move.

FIG. 2b depicts the second operation of the sequence, wherein the dispersion force is “off” at segment n=1 and “on” at segment n=2. Note that the walls of the first segment are “dark” and the walls of the second segment are “light,” representing the status of the dispersion force as “off” and “on,” respectively, for segments 1 and 2. This generates a net force on the core, causing it to move toward the “right.” As for the example depicted in FIGS. 1b through 1d, switching the dispersion force “off” and “on” can be done via modulating the illumination to a particular segment.

FIG. 2c depicts the next operation, wherein the dispersion force is “off” at segment n=2 and “on” at segment n=3. As the core leaves the third segment, it reaches its maximum velocity.

FIG. 2d depicts a twelve segment multi-walled carbon nanotube accelerator, showing the segments alternatively switched “on” and “off” (in time), to accelerate the core.

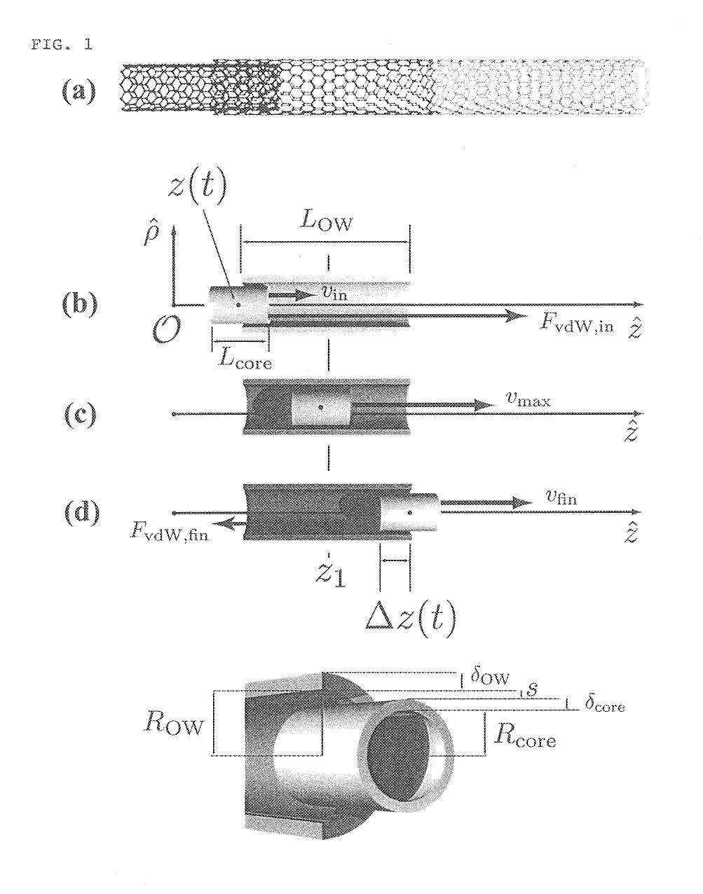

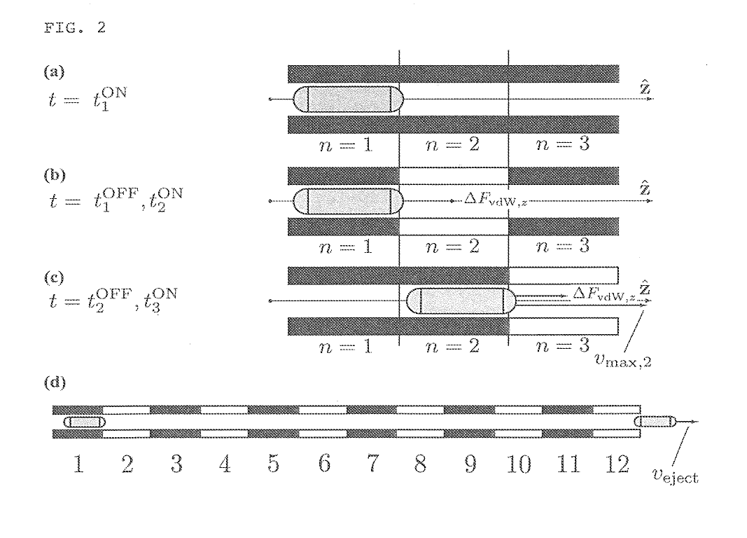

### DESCRIPTION OF EMBODIMENTS OF THE INVENTION

The present invention provides a way to induce movement of a first nanostructure that is contained in a second nanostructure. In the illustrative embodiment, the first nanostructure is an inner tube or core of a multi-wall CNT and the second nanostructure is the outer tube of the same multi-wall CNT. More generally, the first nanostructure is a neutral and polarizable “particle.” For example, in some other embodiments, the first nanostructure is a virus, a medicine, a molecule, etc.

The nanostructures to which the present invention pertains can have a radius in the range of between about 1 nanometer to 10 microns. Although the illustrative embodiments pertain to “carbon” nanostructures, in some other embodiments, the nanostructures are formed of different materials, such as boron-nitride. In accordance with the illustrative embodiment, the tip of the free end of each of a plurality of multi-walled CNTs is removed. This exposes and provides access to an inner core.

To move the core, a difference is created in dispersion-force-affecting properties proximal to the two ends of the outer tube. The dispersion-force-affecting property is a property that affects the dispersion force (e.g., van der Waals, etc.) that arises between the outer tube and the inner core. The dispersion-force-affecting property is a function of the material of which the nanotube is formed. For a carbon nanotube, those properties include, without limitation, an optical property, dielectric function, concentration of free charge carries, and temperature.

The intent is to create a relatively smaller dispersion force toward one end (for example, the “open” end) of the multi-walled CNT and a relatively greater dispersion force toward the other end. This will cause the core to move in the direction of the smaller dispersion force, which effectively reduces the energy of the system.

Depending upon the magnitude of the differential that is created in the dispersion-force-affecting property, and the magnitude of resulting differential in the dispersion forces on one end of multi-walled CNT versus the other, the core can move partially through the tube and then come to rest, or, in fact, the core can be ejected from the outer tube. The tube can be injected at exceedingly high velocities. If the dispersion-force-affecting property is modulated so that the end that exhibits the dispersion force of greater magnitude and the end that exhibits the dispersion force of lesser magnitude are constantly switched, the core will oscillate within the outer tube.

In accordance with the illustrative embodiment, a dispersion-force-affecting property that is altered is the concentration of free charge carriers. In some embodiments, that property is altered via illumination with laser light. That is, one end of the outer tube is illuminated via a laser. This increases the density of free charge carriers in the outer tube at the illuminated end. This results in an increase in the dispersion force between the core and the outer tube at the illuminated end of the tube. The core will move away from the illuminated end of the tube and toward the other end of the tube.

Appendix I provides a detailed explanation of the inventive concept, which is that by modulating or altering the dispersion forces (e.g., van der Waals forces, etc.) that act on the inner core(s) of a multi-walled nanotube, the inner core(s) can be made to move relative to the outer wall(s), and, in fact, can be fully ejected therefrom. Appendix II provides a detailed explanation of ways in which the dispersion force can be modulated or altered.

What is claimed is:

1. A method comprising:
forming a multi-walled nanotube having a core and an outer tube and a first end and a second end;
removing the first end of the multi-walled nanotube, forming an open end; and
creating a differential in a dispersion-force-affecting property of the outer tube as between a region proximal to the open end and the second end.

2. The method of claim 1 wherein the operation of creating a differential further comprises altering the dispersion-force-affecting property of the outer tube so that a dispersion force exhibited between the core and the outer tube proximal to the open end has a relatively lesser magnitude than the dispersion force exhibited between the core and the outer tube near the second end.

3. The method of claim 1 wherein the operation of creating a differential further comprises illumination the second end of the outer tube.

4. The method of claim 3 wherein a laser illuminates the second end of the outer tube.

5. The method of claim 1 wherein the operation of creating a differential further comprises creating a differential that is sufficient to fully eject the core from the outer tube.

6. The method of 1 wherein the core is a virus.

7. The method of claim 1 wherein the core comprises a medicine.

8. A method comprising modulating a magnitude of a dispersion force as a function of a location of a core with respect to a surrounding nanotube, wherein, as a result, the core moves through the surrounding nanotube.

9. The method of claim 8 wherein the surrounding nanotube is functionally divided into a plurality of segments, and wherein the operation of modulating further comprises, with reference to a direction of motion, decreasing the magnitude of the dispersion force for a trailing segment and increasing the magnitude of the dispersion force for a leading segment adjacent thereto.

10. The method of claim 9 wherein a length of each segment of the surrounding nanotube is identical to each other segment, and wherein the operation of modulating further comprises decreasing a period of time between successive increases in the magnitude of the dispersion force as the core proceeds through the surrounding nanotube.

11. The method of 8 wherein the core is a virus.

12. The method of claim 8 wherein the core comprises a medicine.
